(19) United States
(12) Patent Application Publication
(10) Pub. No.: US 2014/0236563 A1
(43) Pub. Date: Aug. 21, 2014

(54) INTEGRATED CIRCUIT SIMULATION METHOD AND SYSTEM

(71) Applicants: Yuping Wu, Beijing (CN); Lan Chen, Beijing (CN)

(72) Inventors: Yuping Wu, Beijing (CN); Lan Chen, Beijing (CN)

(21) Appl. No.: 14/347,676

(22) PCT Filed: Sep. 30, 2011
(86) PCT No.: PCT/CN2011/080409

§ 371 Date: Mar. 27, 2014

(51) Int. Cl. G06F 17/50

(52) U.S. Cl. CPC G06F 17/5022
USPC 703/15

(57) ABSTRACT

Provided is an integrated circuit simulation method. The simulation time points of the entire circuit are divided into a plurality of independent simulation time windows, and according to a logic simulation result, the simulation initial data of the simulation window starting point of each simulation time window is determined, and as an overlapping time region is present at the head-tail connection between adjacent simulation time windows, the circuit simulation calculation of the current simulation time window can be ended at the overlapping time region, so as to implement independent parallel simulation calculation for each simulation time window. Therefore, the time required for the simulation of the entire circuit is approximately the maximum value of the circuit simulation time required for each simulation time window, thereby greatly increasing the efficiency of circuit simulation and effectively shortening the design period of the integrated circuit.

### PRIORITY

The present application is the national phase of International Application PCT/CN2011/080409, entitled “INTEGRATED CIRCUIT SIMULATION METHOD AND SYSTEM,” filed on Sep. 30, 2011, which is incorporated herein by reference in its entirety.

### FIELD

The invention relates to the field of integrated circuit design automation, and more particularly to a simulation method for an integrated circuit and a system thereof

### BACKGROUND

Integrated Circuit (IC) simulation is one of the most important steps in IC design, which is to verify the logic correctness and circuit functions of an IC design on circuit level, to ensure accuracy of the circuit design. IC simulation is also one of the most time-consuming steps in an IC design flow and one of the major factors that affect the cycle of IC design; hence, the cycle of IC design can be effectively shortened by speeding-up the circuit simulation, which may further reduce design costs of an IC product and improve product competitiveness.

IC simulation includes simulation calculation at each of the simulation time points in an IC netlist. According to a conventional IC simulation method, as shown in FIG. 1, simulation calculation is performed for each of the simulation time points with one after another across the entire time domain. That is, the circuit simulation is proceeding as a whole circuit simulation time window, and the simulation calculation starts from a starting time point of the whole circuit simulation time window, runs sequentially and stops at a stopping time point of the whole circuit simulation time window. Therefore, the total simulation time for the circuit equals to the sum of the time used at each of the simulation time points within the whole circuit simulation time window.

As the functions of an IC become increasingly complex, the circuit is continuing to scale up, and it has been a research hotspot to speed-up IC simulation. With the development of computing platform resources, a simulation technique which uses multiple computing resources to perform parallel computing has been proposed to improve the efficiency of IC simulation. However, such parallel computing is currently in the form of simultaneously carrying out different simulation calculation tasks of the same simulation time point, such as parallelized device equation computing, parallelized sparse matrix solving and parallelized simulation computing for different components of a circuit.

Parallelization may improve the speed for a single simulation time point; however, the total simulation time for the circuit still equals to the sum of the time used for each of the simulation time points. The increasing complexity of ICs asks for a circuit simulation method with improved efficiency, to effectively shorten the cycle of IC design and improve product competitiveness.

### SUMMARY

According to an embodiment of the present invention, it is provided a simulation method for an IC and a system thereof, which realize parallel simulation of different time points and may significantly improve simulation efficiency.

In order to achieve the object above, according to an embodiment of the present invention, it is provided a technical solution below.

A simulation method for an IC, includes:

providing a circuit netlist and a logic simulation result of a circuit to be simulated;

dividing simulation time points in the circuit netlist into N consecutive simulation time windows, wherein each of the simulation time windows includes consecutive simulation time points from a simulation window starting point to a simulation window ending point, with the simulation window starting point of the (n+1)^{th} simulation time window being a simulation time point prior to the simulation window ending point of the n^{th} simulation time window so that there is an overlap time region between adjacent simulation time windows, where N and n are integers, 1≦n<N;

determining circuit simulation initial data at the simulation starting point for each of the simulation time windows based on a logic state value of a time point in the logic simulation result that corresponds to the simulation window starting point of each of the simulation time windows;

performing circuit simulation calculations for respective simulation time windows in parallel, based on the circuit simulation initial data for each of the simulation time windows, with the circuit simulation calculation for the n^{th} simulation time window stopped within the overlap time region between the n^{th} simulation time window and the (n+1)^{th} simulation time window; and

performing data combination based on results of the circuit simulation calculations for respective simulation time windows, so as to obtain a simulation result of the circuit to be simulated including all the simulation time points in the circuit netlist.

Optionally, the step of dividing simulation time points in the circuit netlist into N consecutive simulation time windows includes:

obtaining the simulation starting time Tₛ and the simulation ending time Tₑ of the circuit netlist of circuit to be simulated;

determining the number of the simulation time windows to be N;

defining the length of each of the simulation time windows as T_{sim-win}=(Tₑ−Tₛ)/N*(1+k), where the range of k is (0, 1); and

determining N consecutive simulation time windows, the simulation window starting points t_{(s,n)} and the simulation window ending points t_{(e,n)} of the simulation time windows, based on the length of the simulation time windows, where t_{(s,1)}=Tₛ, t_{(e,N)}=Tₑ, t_{(s,n)}=(Tₑ−Tₛ)/N*(n−1−/2), t_{(e,n)}=(Tₑ−Tₛ)/N*(n+k/2), and the overlap time region between the (n+1)^{th} simulation time window and the n^{th} simulation time window is (Tₑ-Tₛ)/N*k, 1<n<N.

Optionally, the range of k is (0, 0.05).

Optionally, the step of determining circuit simulation initial data at its simulation starting point for each of the simulation time windows based on a logic state value of a time point in the logic simulation result that corresponds to the simulation window starting point of each of the simulation time windows includes:

obtaining the logic state value of a time point corresponding to the simulation window starting point of each of the simulation time windows from the logic simulation result;

converting the logic state value into circuit simulation data; and

setting the circuit simulation data corresponding to the simulation window starting point of a simulation time window to be the circuit simulation initial data of the simulation time window at its simulation window starting point.

Optionally, the stopping the circuit simulation calculation for the n^{th} simulation time window within the overlap time region between the n^{th} simulation time window and the (n+1)^{th} simulation time window includes: stopping the circuit simulation calculation for the n^{th} simulation time window at a stopping time point of the circuit simulation calculation for the n^{th} simulation time window, with the stopping time point of the circuit simulation calculation for the n^{th} simulation time window being a predetermined simulation time point within the overlap time region between the n^{th} simulation time window and the (n+1)^{th} simulation time window.

Optionally, the stopping time point of the circuit simulation calculation for the n^{th} simulation time window is the simulation window ending point of the n^{th} simulation time window.

Optionally, the stopping the circuit simulation calculation for the n^{th} simulation time window within the overlap time region between the n^{th} simulation time window and the (n+1)^{th} simulation time window includes: judging whether results of the circuit simulation calculations for the n^{th} simulation time window and the (n+1)^{th} simulation time window are the same in the overlap time region, and if the results are the same, stopping the circuit simulation calculation for the n^{th} simulation time window.

Optionally, the step of performing data combination based on results of the circuit simulation calculations for respective simulation time windows includes:

performing data combination based on an actual simulation calculation result of each of the simulation time windows, wherein the actual simulation calculation result of the (n+1)^{th} simulation time window is a simulation calculation result between the simulation time point at which the circuit simulation calculation for the n^{th} simulation time window stops and the simulation time point at which the circuit simulation calculation for the (n+1)^{th} simulation time window stops, where 1≦n<N.

According to the present invention, it is also provided a simulation system for an IC, including:

an initiation module, adapted to provide a circuit netlist and a logic simulation result of a circuit to be simulated;

a simulation time window division module, adapted to divide simulation time points in the circuit netlist into N consecutive simulation time windows, wherein each of the simulation time windows includes consecutive simulation time points from a simulation window starting point to a simulation window ending point, with the simulation window starting point of the (n+1)^{th} simulation time window being a simulation time point prior to the simulation window ending point of the n^{th} simulation time window so that there is an overlap time region between adjacent simulation time windows, where N and n are integers, 1≦n<N;

a simulation initial data determination module, adapted to determine circuit simulation initial data at its simulation window starting point for each of the simulation time windows based on a logic state value of a time point in the logic simulation result that corresponds to the simulation window starting point of each of the simulation time windows;

a parallel simulation module, adapted to perform circuit simulation calculations for respective simulation time windows in parallel, based on the circuit simulation initial data for each of the simulation time windows, with the circuit simulation calculation for the n^{th} simulation time window stopped within the overlap time region between the n^{th} simulation time window and the (n+1)^{th} simulation time window; and

a simulation result combination module, adapted to combine results of the circuit simulation calculations for respective simulation time windows, so as to obtain a simulation result of the circuit to be simulated including all the simulation time points in the circuit netlist.

In comparison with the prior art, the technical solutions above may bring the following advantages.

A simulation method for an IC and a system thereof according to the embodiments of the present invention divide all the simulation time points of the circuit into multiple independent simulation time windows, and determine simulation initial data at its simulation window starting points for each of the simulation time windows based on a logic simulation result. Since there is an overlap time region between adjacent simulation time windows at where they meet, and the circuit simulation calculation for a simulation time window may be made to stop within the overlap time region, independent, parallel simulation calculations for respective simulation time windows can be achieved; thus the total time required for simulation of the circuit is approximately the longest one of the circuit simulation times required for the simulation time windows, which may improve the efficiency of circuit simulation, effectively shorten the cycle of IC design and improve product competitiveness.

### BRIEF DESCRIPTION OF THE DRAWINGS

The above and other objects, features and advantages of the present invention will be more apparent when read in conjunction with to the accompanying drawings, in which the same reference numerals denote the same components.

FIG. 1 is a schematic diagram illustrating a conventional simulation method for an IC;

FIG. 2 is a schematic diagram illustrating parallel simulation of different simulation time points in a simulation method for an IC according to the present invention;

FIG. 3 a flow chart of a simulation method for an IC according to the present invention;

FIG. 4 is a flow chart of simulation time window division in a simulation method for an IC according to an embodiment of the present invention;

FIG. 5 is a schematic diagram illustrating simulation time window division in a simulation method for an IC according to an embodiment of the present invention;

FIG. 6 is a flow chart of determining simulation initial data of a simulation time window in a simulation method for an IC according to an embodiment of the present invention;

FIG. 7 is a schematic diagram illustrating parallel simulation calculations in a simulation method for an IC according to an embodiment of the present invention;

FIG. 8 is a schematic diagram illustrating the locations of simulation time points in a simulation method for an IC according to an embodiment of the present invention; and

FIG. 9 is a schematic diagram illustrating combining calculation results in a simulation method for an IC according to an embodiment of the present invention.

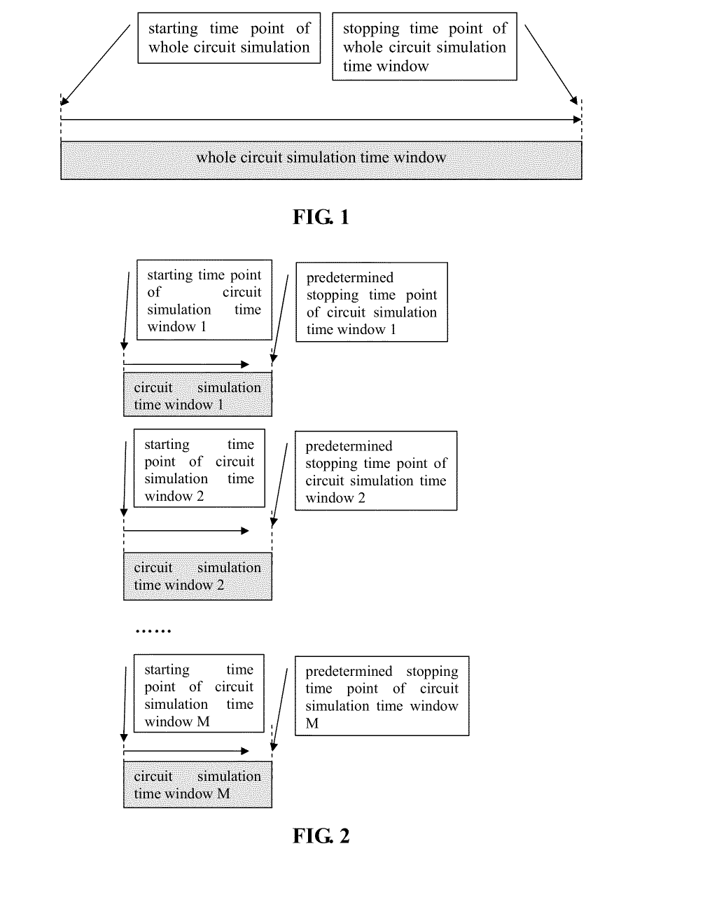

### DETAILED DESCRIPTION

For a better understanding of the above objects, features and advantages of the invention, the embodiments of the present invention will be described in detail hereinafter in conjunction with the accompanying drawings.

Numerous specific details are set forth in the following descriptions, in order to provide a thorough understanding of the present invention. It will be apparent to those skilled in the art that the present invention may be practiced without these specific details, and that equivalents to the present invention may be obtained without deviation from the essence of the present invention; hence the present invention is not limited to the embodiments disclosed herein.

As discussed in the Background the Invention, currently, parallel computing to improve the efficiency of IC simulation is in the form of simultaneously carrying out different simulation calculation tasks at the same simulation time point, such as parallelized device equation computing, parallelized sparse matrix solving and parallelized simulation computing for different components of a circuit. Such parallelization may improve the speed for a single simulation time point; however, the total simulation time for the circuit still equals to the sum of the time used for each of the simulation time points. The increasing complexity of ICs asks for a circuit simulation method with improved efficiency, to effectively shorten the cycle of IC design and improve product competitiveness.

Therefore, according to the present invention, it is provided a simulation method for an IC, which carries out parallel computing of calculation tasks for different time points to achieve circuit simulation with high efficiency. In digital circuit system design, there is a close association between logic simulation results and circuit simulation results, which reflects on the fact that the steady state of logic simulation at a certain clock is consistent with the steady state of circuit-level simulation after the clock but before a new clock arrives. This theoretically founds the parallel computing of simulation time windows for circuit-level simulation of a digital (logic) circuit.

According to the present invention, the whole simulation time window of a circuit is divided into multiple independent simulation time windows, and circuit simulations for the simulation time windows are performed in parallel. As shown in FIG. 2, for a circuit simulation time window 1, simulation calculation starts from a starting time point of the circuit simulation time window 1 on the left, runs sequentially at one simulation time point after another along the time axis from the left to the right, and stops at a predetermined stopping time point in the circuit simulation time window 1; for a circuit simulation time window 2, the simulation calculation starts from a starting time point of the circuit simulation time window 2 on the left, runs sequentially at one simulation time point after another along the time axis from the left to the right, and stops at a predetermined stopping time point in the circuit simulation time window 2; and so forth, for a circuit simulation time window M, the simulation calculation starts from a starting time point of the circuit simulation time window M on the left, runs sequentially at one simulation time point after another along the time axis from the left to the right, and stops at a predetermined stopping time point in the circuit simulation time window M. For each of the simulation time windows 1, 2 . . . M, since the simulation calculations are performed in parallel, the time required for simulation of the circuit is approximately the longest one of the circuit simulation times required for the simulation time windows.

Based on the idea above, in the present invention, the whole simulation time window is divided into multiple independent simulation time windows, and parallel computing of the simulation time windows is realized by using a starting point of each of the simulation time windows as the starting time point of the circuit simulation calculation for the window, and determining a stopping time point of the circuit simulation calculation for the window within the simulation time window. The simulation method for an IC may include the following steps:

providing a circuit netlist and a logic simulation result of a circuit to be simulated;

dividing simulation time points in the circuit netlist into N consecutive simulation time windows, wherein each of the simulation time windows includes consecutive simulation time points from a simulation window starting point to a simulation window ending point, with the simulation window starting point of the (n+1)^{th} simulation time window being a simulation time point prior to the simulation window ending point of the n^{th} simulation time window so that there is an overlap time region between adjacent simulation time windows, where N and n are integers, 1≦n<N;

determining circuit simulation initial data at its simulation window starting point for each of the simulation time windows based on a logic state value of a time point in the logic simulation result that corresponds to the simulation window starting point of each of the simulation time windows;

performing circuit simulation calculations for respective simulation time windows in parallel, based on the circuit simulation initial data for each of the simulation time windows, with the circuit simulation calculation for the n^{th} simulation time window stopped within the overlap time region between the n^{th} simulation time window and the (n+1)^{th} simulation time window; and

performing data combination based on results of the circuit simulation calculations for respective simulation time windows, so as to obtain a simulation result of the circuit to be tested including all the simulation time points in the circuit netlist.

All the simulation time points of the circuit are divided into multiple independent simulation time windows, and simulation initial data for each of the simulation time windows at its simulation window starting point is determined based on a logic simulation result; and there is an overlap time region between adjacent simulation time windows at where they meet, and the circuit simulation calculation for a simulation time window may be made to stop within the overlap time region, hence independent, parallel simulation calculations for respective simulation time windows can be achieved. Therefore, the total time required for simulation of the circuit is approximately the longest one of the circuit simulation times required for the simulation time windows, which may improve the efficiency of circuit simulation, effectively shorten the cycle of IC design and improve product competitiveness.

For a better understanding of the technical solutions and technical effects of the present invention, the embodiments of the present invention will be described in detail hereinafter in conjunction with a flow chart of the method according the present invention.

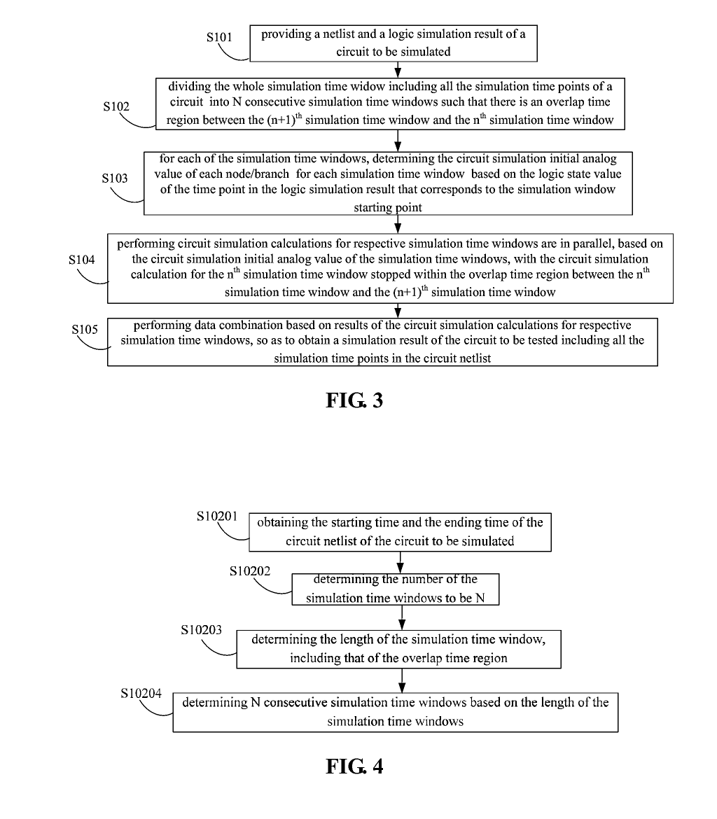

FIG. 3 shows a flow chart of a simulation method for an IC according to the present invention.

At step S101, a circuit netlist and a logic simulation result of a circuit to be simulated are provided.

The circuit to be simulated may be a digital circuit, and the logic simulation result may include information such as logic state values at the time points.

The circuit netlist, i.e., circuit simulation netlist, may be a circuit file generated in a hardware description language during IC design, which is used for circuit simulation.

It is noted that, the circuit netlist/circuit simulation netlist herein may include at least: a circuit netlist including parasitic parameters extracted from an IC layout by a circuit and parasitic parameter extraction software tool; excitation and loads applied to the IC; and circuit node initial voltage setting, circuit node voltage and branch current output setting, commands (including starting and stopping time) for initiating circuit simulation analysis (e.g. transient response analysis), commands for subsequent measurement and analysis, etc.

At step S102, simulation time points in the circuit netlist are divided into N consecutive simulation time windows such that there is an overlap time region between adjacent simulation time windows.

Specifically, each of the simulation time windows may include consecutive simulation time points from a simulation window starting point to a simulation window ending point, with the simulation window starting point of the (n+1)^{th} simulation time window being a simulation time point prior to the simulation window ending point of the n^{th} simulation time window so that there is an overlap time region between adjacent simulation time windows, where N and n are integers, 1≦n<N;

In the embodiment, as shown in FIG. 4, the dividing simulation time points in the circuit netlist into N consecutive simulation time windows may include the following steps.

At step S10201, a starting time and an ending time of the circuit netlist of the circuit to be tested are obtained.

The simulation starting time Tₛ and the simulation ending time Tₑ of the circuit to be simulated may be obtained from the logic simulation result, or from the circuit simulation netlist, e.g., time points at which the excitation starts and stops in the circuit simulation netlist, or a starting time point and a stopping time point specified by a transient response analysis command in the circuit simulation netlist file.

At step S10202, the number of the simulation time windows is determined to be N.

The number of the simulation time windows, i.e., the number of simulation time windows where parallel computing is to be performed, may be determined according to the number of resources available for parallel computing. The resources available for parallel computing may include, e.g., idle computers in the current local area network that can be used for parallel computing, and the number of the simulation time windows may be the number of the idle computers or the number of some of the idle computers. The number of the simulation time windows described herein is for illustrative purposes only, which may also be determined according to a specific design requirement.

At step S10203, the length of the simulation time window is determined, and the length of the simulation time window includes that of the overlap time region.

In the embodiment, the length of the simulation time window may be defined as T_{sim-win}=(Tₑ−Tₛ)/N*(1+k), where the range of k may be (0, 1), more preferably, (0, 0.05). In simulation time window division, k results in an overlap time region between adjacent simulation time windows at where they meet; and when k is small, it has little effect on the simulation time for the window while maintaining the overlap time region.

At step S10204, N consecutive simulation time windows are determined based on the length of the simulation time windows. That is, by determining the simulation window starting points t_{(s,n)} and the simulation window ending points t_{(e,n)} of the simulation time windows, all simulation time points of each of the simulation time windows are determined, which include all consecutive time points between the simulation window starting point t_{(s,n)} and the simulation window ending points t_{(e,n)} within the simulation time window.

In the embodiment, assuming t_{(s,n)}=(Tₑ−Tₛ)/N*(n−1−k/2), t_{(e,n)}=(Tₑ−Tₛ)/N*(n+k/2), 1<n<N, then t_{(s,n+1)}=((Tₑ−Tₛ)/N*(n−k/2), and the length of the overlap time region between the (n+1)^{th} simulation time window and the n^{th} simulation time window is (Tₑ−Tₛ)/N*k.

In addition, when n=1, i.e., for the first simulation time window, its simulation window starting point t_{(s,1)}=Tₛ; when n=N, t_{(e,N)}=Tₑ.

The dividing all the simulation time points of a circuit into multiple consecutive simulation time windows with overlap time regions according to an embodiment of the present invention is described above. As shown in FIG. 5, where four simulation time windows result according to an embodiment of the present invention, there are an overlap time region D_{1,2} between a simulation time window 1 and a simulation time window 2, an overlap time region D_{2,3} between the simulation time window 2 and a simulation time window 3, and an overlap time region D_{3,4} between the simulation time window 3 and a simulation time window 4; and the overlap time regions are for determining a stopping time point of the circuit simulation calculation for each of the simulation time windows.

At step S103, circuit simulation initial data at its simulation window starting point for each of the simulation time windows are determined based on a logic state value of a time point in the logic simulation result that corresponds to the simulation window starting point of each of the simulation time windows.

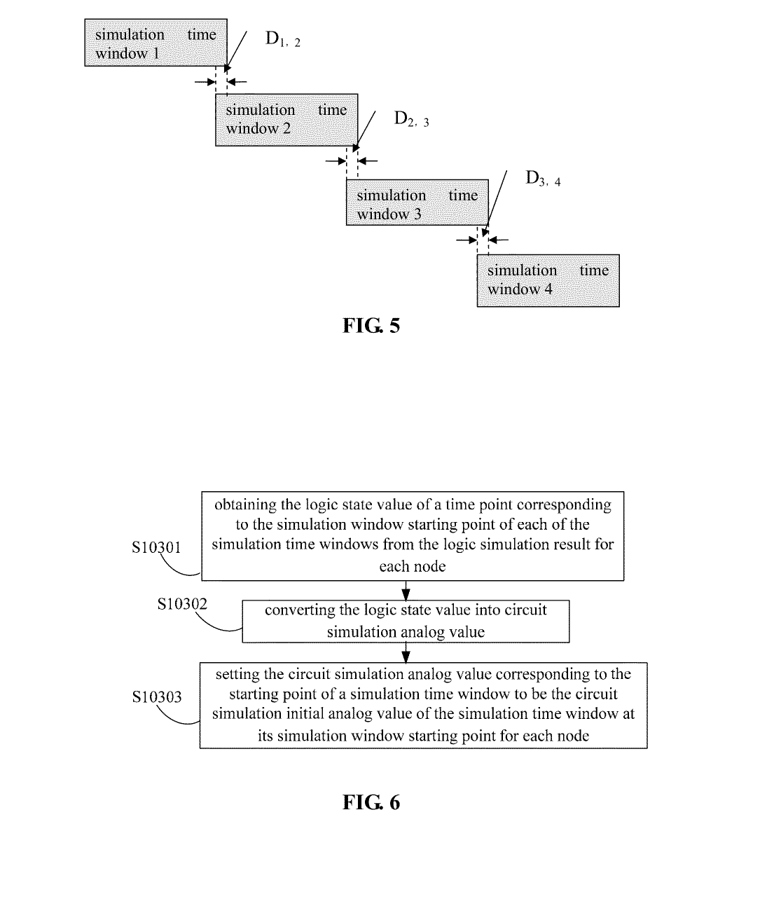

In the embodiment, as shown in FIG. 6, specifically, the determining circuit simulation initial data for each of the simulation time windows at its simulation window starting point may include the following steps.

At step S10301, the logic state value of a time point corresponding to the simulation window starting point of each of the simulation time windows is obtained from the logic simulation result.

The logic state value of a time point corresponding to the simulation window starting point of each of the simulation time windows may be obtained by traversing the logic simulation result over time.

At step S10302, the logic state value is converted into circuit simulation data.

The obtained logic state value may be converted into circuit simulation data on continuous space, e.g. a voltage value of a circuit node.

At step S10303, the circuit simulation data corresponding to the simulation window starting point of a simulation time window is set to be the circuit simulation initial data of the simulation time window at its simulation window starting point.

Thus the circuit simulation initial data for each of the simulation time windows at its simulation window starting point are obtained, and circuit simulation calculation at the other simulation time points of the each of the simulation time windows may be performed based on the circuit simulation initial data, with the simulation window starting point as a starting time point of the circuit simulation calculation.

At step S104, circuit simulation calculations for respective simulation time windows are performed in parallel, based on the circuit simulation initial data for each of the simulation time windows, with the circuit simulation calculation for the n^{th} simulation time window stopped within the overlap time region between the n^{th} simulation time window and the (n+1)^{th} simulation time window, where 1≦n<N. For the N^{th} simulation time window, the stopping time point of its circuit simulation calculation is the simulation window ending point of the N^{th} simulation time window, i.e., the stopping time point Tₑ of the entire simulation of the circuit to be simulated.

Based on the dividing into simulation time windows and the determining the circuit simulation initial data for each of the simulation time windows, the simulation calculations may be performed in parallel from the simulation window starting points of respective simulation time windows; and the circuit simulation calculation for the n^{th} simulation time window may stop within the overlap time region between the n^{th} simulation time window and the (n+1)^{th} simulation time window, thereby realizing parallel simulation computing of multiple simulation time windows, i.e., parallel simulation calculations of different simulation time points.

In some embodiments, a certain simulation time point within the overlap time region between the n^{th} simulation time window and the (n+1)^{th} simulation time window may be specified as the stopping time point of the circuit simulation calculation for the n^{th} simulation time window, and the circuit simulation calculation for the n^{th} simulation time window stops at the stopping time point. For example, the simulation window ending point of the n^{th} simulation time window may be specified as the stopping time point of the circuit simulation calculation for the n^{th} simulation time window; or, some other simulation time point within the overlap time region may be specified as the stopping time point of the circuit simulation calculation for the simulation time window according to a specific design requirement such as convergence and computing efficiency.

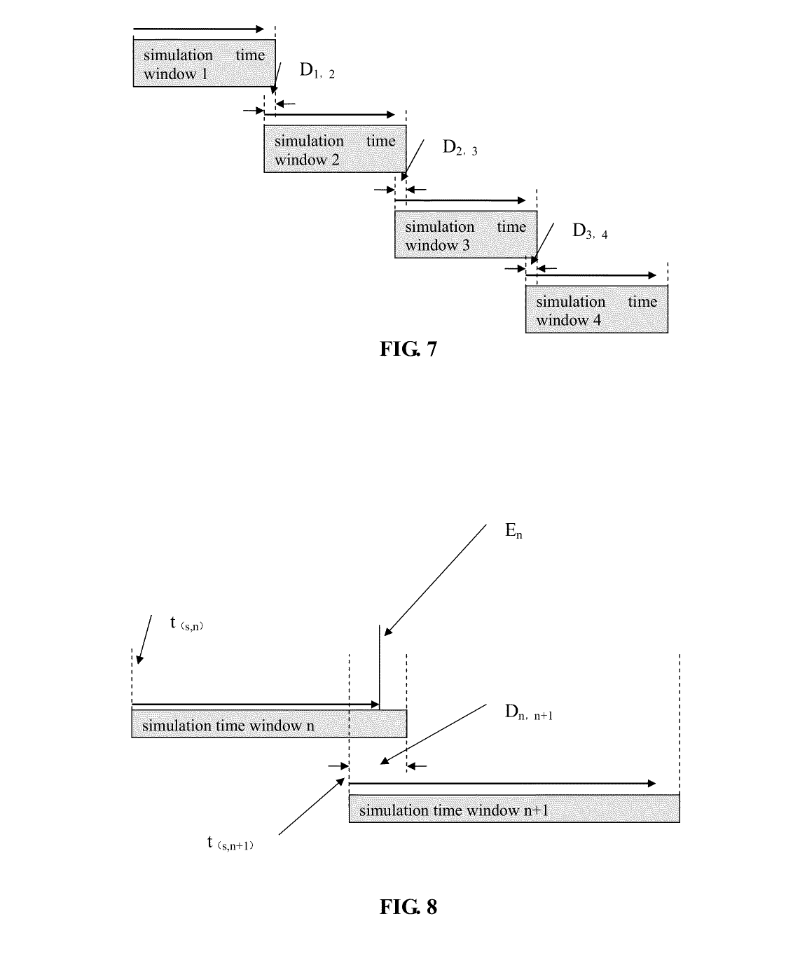

As shown in FIG. 7, circuit simulation calculations for the simulation time window 1, the simulation time window 2, the simulation time window 3 and the simulation time window 4 are performed in parallel. Each of the simulation windows has its own circuit simulation initial value and an approach to determine the stopping point of its circuit simulation calculation; hence the simulation calculation of each of the simulation time windows can be performed independently. In each of the simulation time windows, simulation may be performed at each of the simulation time points along the time axis one after another, and stop at a certain simulation time point within the overlap time region.

In a more preferred embodiment, the stopping point of the circuit simulation calculation of the current simulation time window n may be determined by judging whether results of the circuit simulation calculations for the n^{th} simulation time window and the (n+1)^{th} simulation time window are the same at the same simulation time points in the overlap time region, to ensure an effective ending within each of the simulation time windows and convergence of simulation calculations for the simulation time windows, and fully improve the efficiency of simulation computing. For an approach for simulation calculation at different time points in a simulation time window in the preferred embodiment, as shown in FIG. 8, the circuit simulation calculation for the simulation time window n starts from the simulation window starting point t_{(s,n)} of the simulation time window n; runs along the time axis one simulation time point after another; and when it enters the simulation time window n+1 at the simulation window starting point t_{(s,n+1)}, it is judged whether the obtained results (e.g., voltage value) of the circuit simulation calculations for the simulation time window n and the simulation time window n+1 are the same at the same simulation time point, and if the results are the same, the simulation time point is determined as the stopping time point Eₙ of the circuit simulation calculation for the simulation time window n, otherwise, the simulation calculation goes on to the next simulation time point and the approach repeats, until it is determined that a result obtained from the circuit simulation calculation for the simulation time window n equals to a result obtained from the circuit simulation calculation for the simulation time window n+1 at the same simulation time point.

At step S105, data combination is performed based on results of the circuit simulation calculations for respective simulation time windows, so as to obtain a simulation result of the circuit to be simulated including all the simulation time points in the circuit netlist.

For a final simulation result obtained from combining results of circuit simulation calculations for respective simulation windows, since time points in the overlap time region occur twice in adjacent simulation time windows, only one of the occurrences are used for combination in the final simulation result, in order to avoid duplication.

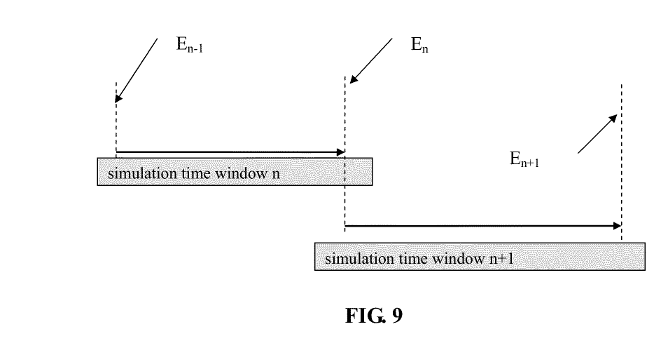

In the embodiment, actual simulation calculation results of respective simulation time windows may be combined. As shown in FIG. 9, the actual simulation calculation result of the n+1 simulation time window is a calculation result between the stopping time point Eₙ of the circuit simulation calculation for the n^{th} simulation time window and the stopping time point Eₙ₊₁ of the circuit simulation calculation for the (n+1)^{th} simulation time window, where 1<n<N. In combining, the actual simulation calculation result of the first simulation time window is a simulation result between the simulation window starting point Tₛ of the first simulation time window (i.e., the starting time of the entire simulation of the circuit to be tested) and the stopping time point E₁ of the circuit simulation calculation for the first simulation time window, and this simulation result between the two time points becomes part of the simulation result of the circuit to be tested; the actual simulation calculation result of the second simulation time window is a simulation result between the simulation window ending point E₁ of the first simulation time window and the stopping time point E₂ of the circuit simulation calculation for the second simulation time window, and this simulation result between the two time points becomes another part of the simulation result of the circuit to be tested; and so forth, the actual simulation calculation result of the N^{th} simulation time window is a simulation result between the simulation window ending point E_{N-1} of the (N−1)^{th} simulation time window and the stopping time point Tₑ of the entire simulation of the circuit to be tested. By combining the actual simulation calculation results from the first simulation time window to the N^{th} simulation time window, the whole simulation result of the circuit to be simulated is obtained.

Therefore, according to the embodiment, the simulation result of the circuit to be simulated is obtained through performing simulation calculations of different time points in parallel.

A simulation method for an IC according to the present invention and its embodiments is described in detail above. In addition, according to the present invention, it is also provided a simulation system for an IC based on the method above, including:

an initiation module, adapted to provide a circuit netlist and a logic simulation result of a circuit to be simulated;

a simulation time window division module, adapted to divide simulation time points into N consecutive simulation time windows, wherein each of the simulation time windows includes consecutive simulation time points from a simulation window starting point to a simulation window ending point, with the simulation window starting point of the (n+1)^{th} simulation time window being a simulation time point prior to the simulation window ending point of the n^{th} simulation time window so that there is an overlap time region between adjacent simulation time windows, where N and n are integers, 1≦n<N;

a simulation initial data determination module, adapted to determine circuit simulation initial data for each of the simulation time windows at its simulation window starting point, based on a logic state value of a time point in the logic simulation result that corresponds to the simulation window starting point of each of the simulation time windows;

a parallel simulation module, adapted to perform circuit simulation calculations for respective simulation time windows in parallel, based on the circuit simulation initial data for each of the simulation time windows, with the circuit simulation calculation for the n^{th} simulation time window stopped within the overlap time region between the n^{th} simulation time window and the (n+1)^{th} simulation time window; and

a simulation result combination module, adapted to combine results of the circuit simulation calculations for respective simulation time windows, so as to obtain a simulation result of the circuit to be simulated including all the simulation time points in the circuit netlist

Preferred embodiments of the present invention are described above for illustrative purposes only, and shall not be considered limiting the present invention in any way.

The present invention is disclosed above with its preferred embodiments, which shall not be considered limiting the present invention. Numerous alternations, modifications and equivalents may be made to the technical solutions of the present invention by those skilled in the art in light of the methods and technical contents disclosed herein without deviation from the scope of the present invention. Therefore, any alternations, modifications and equivalents made to the embodiments herein according to the technical essence of the present invention without deviation from the scope of the present invention shall fall within the scope of protection of the present invention.

1. A simulation method for an IC, comprising:
providing a circuit netlist and a logic simulation result of a circuit to be simulated;
dividing simulation time points in the circuit netlist into N consecutive simulation time windows, wherein each of the simulation time windows comprises consecutive simulation time points from a simulation window starting point to a simulation window ending point, with the simulation window starting point of the (n+1)^{th} simulation time window being a simulation time point prior to the simulation window ending point of the n^{th} simulation time window so that there is an overlap time region between adjacent simulation time windows, where N and n are integers, 1≦n<N;
determining circuit simulation initial data for each of the simulation time windows, based on a logic state value of a time point in the logic simulation result that corresponds to the simulation window starting point of each of the simulation time windows;
performing circuit simulation calculations for respective simulation time windows in parallel, based on the circuit simulation initial data for each of the simulation time windows, with the circuit simulation calculation for the n^{th} simulation time window stopped within the overlap time region between the n^{th} simulation time window and the (n+1)^{th} simulation time window; and
performing data combination based on results of the circuit simulation calculations for respective simulation time windows, so as to obtain a simulation result of the circuit to be tested comprising all the simulation time points in the circuit netlist.

2. The method according to claim 1, wherein the step of dividing simulation time points in the circuit netlist into N consecutive simulation time windows comprises:
obtaining the circuit simulation starting time Tₛ and the circuit simulation ending time Tₑ of the circuit netlist to be simulated;
determining the number of the simulation time windows to be N;
defining the length of each of the simulation time windows as T_{sim-win}=(Tₑ−Tₛ)/N*(1+k), where the range of k is (0, 1); and
determining N consecutive simulation time windows, the simulation window starting points t_{(s,n)} and the simulation window ending points t_{(e,n)} of the simulation time windows, based on the length of the simulation time windows, where t_{(s,1)}=Tₛ, t_{(e,N)}=Tₑ, t_{(s,n)}=(Tₑ−Tₛ)/N*(n−1−k/2), t_{(e,n)}=(Tₑ−Tₛ)/N*(n+k/2), and the overlap time region between the (n+1)^{th} simulation time window and the n^{th} simulation time window is (Tₑ−Tₛ)/N*k, 1<n<N.

3. The method according to claim 2, optimally wherein the range of k is (0, 0.05).

4. The method according to claim 1, wherein the step of determining circuit simulation initial data at its simulation window starting point for each of the simulation time windows based on a logic state value of a time point in the logic simulation result that corresponds to the simulation window starting point of each of the simulation time windows comprises:
obtaining the logic state value of a time point corresponding to the simulation window starting point of each of the simulation time windows from the logic simulation result;
converting the logic state value into circuit simulation data; and
setting the circuit simulation analog value corresponding to the simulation window starting point of a simulation time window to be the circuit simulation initial data of the simulation time window at its simulation window starting point.

5. The method according to claim 1, wherein the stopping the circuit simulation calculation for the n^{th} simulation time window within the overlap time region between the n^{th} simulation time window and the (n+1)^{th} simulation time window comprises:
stopping the circuit simulation calculation for the n^{th} simulation time window at a stopping time point of the circuit simulation calculation for the n^{th} simulation time window, with the stopping time point of the circuit simulation calculation for the n^{th} simulation time window being a predetermined simulation time point within the overlap time region between the n^{th} simulation time window and the (n+1)^{th} simulation time window.

6. The method according to claim 5, wherein the stopping time point of the circuit simulation calculation for the n^{th} simulation time window is the simulation window ending point of the n^{th} simulation time window.

7. The method according to claim 1, wherein the stopping the circuit simulation calculation for the n^{th} simulation time window within the overlap time region between the n^{th} simulation time window and the (n+1)^{th} simulation time window comprises:
judging whether results of the circuit simulation calculations for the n^{th} simulation time window and the (n+1)^{th} simulation time window are the same in the overlap time region, and if the results are the same, stopping the circuit simulation calculation for the n^{th} simulation time window.

8. The method according to claim 1, wherein the step of performing data combination based on results of the circuit simulation calculations for respective simulation time windows comprises:
performing data combination based on an actual simulation calculation result of each of the simulation time windows, wherein the actual simulation calculation result of the (n+1)^{th} simulation time window is a simulation calculation result between the simulation time point at which the circuit simulation calculation for the n^{th} simulation time window stops and the simulation time point at which the circuit simulation calculation for the (n+1)^{th} simulation time window stops, where 1≦n<N.

9. A simulation system for an IC, comprising:
an initiation module, adapted to provide a circuit netlist and a logic simulation result of a circuit to be simulated;
a simulation time window division module, adapted to divide simulation time points in the circuit netlist into N consecutive simulation time windows, wherein each of the simulation time windows comprises consecutive simulation time points from a simulation window starting point to a simulation window ending point, with the simulation window starting point of the (n+1)^{th} simulation time window being a simulation time point prior to the simulation window ending point of the n^{th} simulation time window so that there is an overlap time region between adjacent simulation time windows, where N and n are integers, 1≦n<N;
a simulation initial data determination module, adapted to determine circuit simulation initial data at its simulation window starting point for each of the simulation time windows based on a logic state value of a time point in the logic simulation result that corresponds to the simulation window starting point of each of the simulation time windows;
a parallel simulation module, adapted to perform circuit simulation calculations for respective simulation time windows in parallel, based on the circuit simulation initial data for each of the simulation time windows, with the circuit simulation calculation for the n^{th} simulation time window stopped within the overlap time region between the n^{th} simulation time window and the (n+1)^{th} simulation time window; and
a simulation result combination module, adapted to combine results of the circuit simulation calculations for respective simulation time windows, so as to obtain a simulation result of the circuit to be tested comprising all the simulation time points in the circuit netlist.
